(19) United States
(12) Patent Application Publication
(10) Pub. No.: US 2024/0362614 A1
(43) Pub. Date: Oct. 31, 2024

(54) Method for controlling a contactless transaction and corresponding communicating object

(71) Applicant: ORANGE, Issy-les-Moulineaux (FR)

(72) Inventors: Emmanuel Le Huerou, CHATILLON CEDEX (FR); François Toutain, CHATILLON CEDEX (FR)

(21) Appl. No.: 18/573,957

(22) PCT Filed: Jun. 17, 2022
(86) PCT No.: PCT/FR2022/051183

§ 371 Date: Dec. 22, 2023

(30) Foreign Application Priority Data
Jul. 6, 2021 (FR) FR2107284

(51) Int. Cl. G06Q 20/32; G06Q 20/18; G07C 9/29

(52) U.S. Cl. CPC G06Q 20/327; G06Q 20/18; G07C 9/29

(57) ABSTRACT

A method for controlling a contactless transaction between a communicating object and a communication device, during which the communicating object receives, from the communication device, a request containing data relating to the transaction. The method includes the communicating object autonomously executing the following: extracting information relating to the transaction from the received request; comparing the extracted information with use context data in relation to the communicating object that have been determined by the object; and activating sending, to the communication device, a response to the request authorizing the transaction when there is a match between the information relating to the transaction and the use context data.

### FIELD OF THE INVENTION

The invention relates to contactless communications, that is to say wireless communications, for the transmission of data between a communicating object and a communication device. More specifically, the invention relates to transactions implemented during these contactless communications, such as in particular banking transactions, accessing a means of transport or a secure location, ordering one or more products or services, etc. and the way in which a communicating object, such as for example a connected vehicle, a smartphone, a connected watch, controls these contactless transactions with a communication device, typically a reader, a payment point, an access gate, etc.

### PRIOR ART

It is possible at present to implement a transaction using a communicating or connected object. If for example the transaction is a payment for a product or a service, a user who has made a purchase is able to pay for it using a connected object, such as a bank card, a smartphone, a connected watch, etc. To this end, the user knows the context of their purchase (the object they are purchasing, the location of the purchase, the merchant, etc.). Thus, when the merchant presents the user with an electronic payment terminal (EPT) on which the price corresponding to this purchase and sometimes the object being purchased is displayed, the user checks this information and, if they agree with said information, brings their connected object towards the EPT in order to authorize the transaction if this is contactless. If the contactless transaction is not possible, the user is obliged to enter a code on the EPT to authorize the transaction.

If the transaction is accessing a secure premises or a means of transport (the metro for example) via an access gate, the user knows the location and the conditions of this access. Thus, when the user approaches a terminal or a gate, they simply need to bring their connected object (access badge, transport card, smartphone, etc.) close in order to validate access.

In recent years, more sophisticated connected objects, such as for example connected vehicles, have also emerged. These connected vehicles are equipped with:
short-range or medium-range wireless communication means such as for example Bluetooth, LTE (Long Term Evolution), DSRC (Dedicated Short Range Communication) Wi-Fi, C-V2X (Cellular Vehicle To Everything), etc.
transaction means, such as for example an eSIM (embedded subscriber identification module) card installed in the vehicle, an electronic wallet (e-wallet) embedded in the computing infrastructure of the vehicle and in which one or more bank card digital currency units (tokens) have been preloaded, etc. By virtue of such technology, contactless transactions are able to be implemented in the connected vehicle in order to access products or services that include for example parking in a car park, paying a motorway toll, using a service station (petrol or electrical recharging, washing, etc.), a maintenance or servicing operation, delivery of an order at a drive-in service (fast food, click & collect, etc.).

One disadvantage of using such a connected vehicle is that the user is obliged, as in previous use cases, to check all information relating to the transaction, which information is displayed for example on a dashboard console, before authorizing the transaction, by clicking on a “validate” button displayed on the console, or before declining the transaction, by clicking on a “cancel” button displayed on the console. Although such a connected vehicle makes it easier to implement transactions for a user located on board, the user is still obliged to intervene during the transaction in order to check and validate it.

### AIM AND SUMMARY OF THE INVENTION

One of the aims of the invention is to rectify drawbacks of the abovementioned prior art by allowing a connected object to control the implementation of a contactless transaction with a communication device completely autonomously and securely, without a user of the object needing to intervene on the connected object or manipulate it.

To this end, one subject of the present invention relates to a method for controlling a contactless transaction between a communicating object and a communication device, during which the communicating object receives, from the communication device, a request containing data relating to the transaction.

Such a method is noteworthy in that the communicating object autonomously executes the following:
extracting information relating to the transaction from the received request,
comparing the extracted information with use context data in relation to the communicating object that have been determined by the object,
activating sending, to the communication device, of a response to the request authorizing the transaction when there is a match between the information relating to the transaction and the use context data.

The invention advantageously allows a connected object, able to communicate contactlessly with a communication device as part of the implementation of a transaction, to be provided with a decision-making mechanism for checking:
whether or not a request containing data relating to the transaction and received from the communication device is legitimate,
and, if this request is considered to be legitimate by the object, to respond favorably to this request in order to implement the transaction.

One advantage of the invention is that such a check is carried out completely autonomously by the communicating object, such as for example a connected vehicle, a connected watch, a connected card, that is to say without any human intervention or manipulation with respect to the object. Thus, by virtue of the invention, the connected object decides on its own initiative whether it is authorized to carry out a contactless transaction correctly with the communication device, such a transaction being for example a payment, the delivery of a product or service, accessing a locker, a means of transport, etc.

Such a decision-making mechanism installed in the communicating object also makes it possible to avoid or limit the development and deployment, in the network, of preventive processing tools intended to check the legitimacy of a request, these tools being technically complex and expensive.

According to one particular embodiment, in the absence of a match between the information relating to the transaction and the use context data, the communicating object activates sending, to the communication device, of a response to the request declining the transaction, or does not respond to the request.

By virtue of this embodiment, the communicating object is able to autonomously process the reception of any request containing data relating to a transaction that might not be intended for this communicating object but for another communicating object or else that might be intended for the communicating object for fraudulent purposes or by mistake. To this end, the communicating object is able to send a response to the request declining the transaction, thereby ending the communication between the communicating object and the communication device. As an alternative, the communicating object may ignore this request and not respond to it, in order to save the resources of the battery of the communicating object and/or the bandwidth of the wireless communication network between the communicating object and the communication device.

According to another particular embodiment, during the comparison of the extracted information with the use context data, at least one additional datum relating to the transaction is determined, said at least one additional datum being added to the response to the request authorizing the transaction.

By virtue of this embodiment, the communicating object is able:
to autonomously generate one or more additional data relating to the transaction, such as for example an identifier associated with the user of the object at the time of the transaction, the identity of this user, the location of the transaction, etc., and
to cleverly communicate these one or more additional data in the response to the request authorizing the transaction.

The response to the request authorizing the transaction is thus advantageously enriched with payload data that the communication device is able to transmit to the manager of the transaction or of the communicating object or else to the provider of the product or service, for the purpose of processing/archiving/tracing transactions that have been carried out by a user of the particular communicating object.

According to another particular embodiment, when the transaction is a payment and the communicating object comprises at least two means of payment associated respectively with two different users, the at least one additional datum is an identifier of the means of payment associated with the user of the object at the time of the transaction.

By virtue of this embodiment, if the communicating object is able to implement a payment for multiple different potential users, the communicating object is advantageously capable of autonomously and automatically deducing the means of payment of the user actually involved in this payment.

According to another particular embodiment, the comparison of the extracted information with the use context data comprises the following:
generating a reliability score for the comparison,
comparing the generated score with a threshold,
   on the result of the comparison:
   “activating sending, to the communication device, of a response to the request authorizing the transaction,”
   activating sending, to the communication device, of a response to the request declining the transaction or not responding to the request.

Such an embodiment constitutes a decision-making mechanism that is very simple to implement and therefore suitable for sparing the computing resources of the communicating object, which are generally low. This score is then compared with a reference threshold, for example 0.5, which characterizes a transaction situation that is for example valid above this threshold and a transaction situation that is invalid below this threshold (the opposite is also possible depending on the established comparison convention). If the assigned score is greater than (or greater than or equal to) this reference threshold, the communicating object sends a response to the request authorizing the transaction. If the assigned score is less than (or less than or equal to) this reference threshold, the communicating object does not respond to the request or sends a response to the request declining the transaction.

According to another particular embodiment, the use context data in relation to the communicating object are representative of an environment in which the communicating object is located or contain at least one operating datum in relation to a transaction of the communicating object.

Such use context data, determined fully autonomously by the communicating object, are particularly accurate and reliable since they are related to the very environment in which the communicating object is located and/or are based on operating data in relation to this object.

According to another particular embodiment, the at least one operating datum in relation to the communicating object is a current operating parameter recorded by the communicating object or an element of a history of the communications carried out by the communicating object.

According to another particular embodiment, the use context data representative of an environment in which the communicating object is located are contained in a message received by the communicating object from the communication device or from a message-transmitting device located in said environment.

Such use context data constitute additional relevant data that may advantageously be used in the abovementioned comparison step, in addition to the use context data obtained in the previous embodiment. These may be for example the name of the provider of the product or service that is the subject of the transaction, the type of product or service, or a location where the product or service is located.

According to another particular embodiment, the use context data representative of an environment in which the communicating object is located contain a datum from at least one sensor belonging to the communicating object.

The various abovementioned embodiments or implementation features may be added, independently or in combination with one another, to the method for controlling a contactless transaction defined above.

The invention also relates to a communicating object having abilities to control a contactless transaction with a communication device, the communicating object comprising a processor that is configured to receive, from the communication device, a request containing data relating to the transaction.

Such a communicating object is noteworthy in that the processor of the communicating object autonomously executes the following:
extracting information relating to the transaction from the received request,
comparing the extracted information with use context data in relation to the communicating object that have been determined by the object,
activating sending, to the communication device, of a response to the request authorizing the transaction when there is a match between the information relating to the transaction and the use context data.

The invention also relates to a system for controlling a contactless transaction. Such a system is noteworthy in that it comprises:
a communicating object implementing the abovementioned method for controlling a contactless transaction,
a contactless communication device that is configured to send, to the communicating object, a request containing data relating to the transaction.

The invention also relates to a computer program comprising instructions for implementing the method for controlling a contactless transaction according to the invention, according to any one of the particular embodiments described above, when said program is executed by a processor.

Such instructions may be stored durably in a non-transient memory medium of the communicating object implementing the method for controlling a contactless transaction according to the invention.

This program may use any programming language and be in the form of source code, object code or intermediate code between source code and object code, such as in a partially compiled form, or in any other desirable form.

The invention also targets a computer-readable recording medium or information medium containing instructions of a computer program as mentioned above. The recording medium may be any entity or device capable of storing the program. For example, the medium may comprise a storage means, such as a ROM, for example a CD-ROM or a microelectronic circuit ROM, or else a magnetic recording means, for example a mobile medium, a hard disk or an SSD.

On the other hand, the recording medium may be a transmissible medium such as an electrical or optical signal, which may be routed via an electrical or optical cable, by radio or by other means, such that the computer program that it contains is able to be executed remotely. The program according to the invention may in particular be downloaded from a network, for example an Internet network.

As an alternative, the recording medium may be an integrated circuit in which the program is incorporated, the circuit being designed to execute or to be used in the execution of the abovementioned method for controlling a contactless transaction. According to one exemplary embodiment, the present technique is implemented by way of software components and/or hardware components. With this in mind, the term “module” may correspond in this document equally to a software component, to a hardware component or to a set of software components and hardware components.

### BRIEF DESCRIPTION OF THE DRAWINGS

Other features and advantages will become apparent on reading particular embodiments of the invention, which are given by way of illustrative and non-limiting examples, and the appended drawings, in which:

FIG. 1A shows a system for controlling a contactless transaction according to a first embodiment of the invention,

FIG. 1B shows a system for controlling a contactless transaction according to a second embodiment of the invention,

FIG. 1C shows a system for controlling a contactless transaction according to a third embodiment of the invention,

FIG. 2 shows a communicating object in one embodiment of the invention,

FIG. 3 shows the main actions implemented in the method for controlling a contactless transaction, according to one particular embodiment of the invention,

FIG. 4 shows one embodiment of a step of determining whether or not the transaction is legitimate, implemented in the method for controlling a contactless transaction according to the invention.

### DETAILED DESCRIPTION OF ONE EMBODIMENT OF THE INVENTION

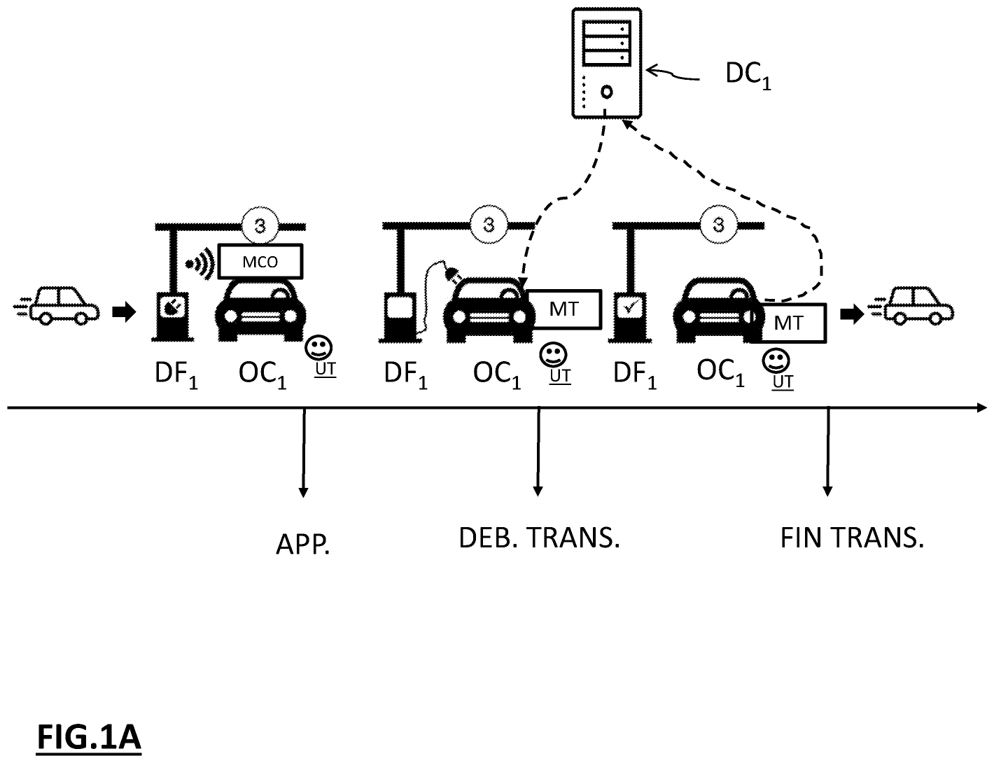

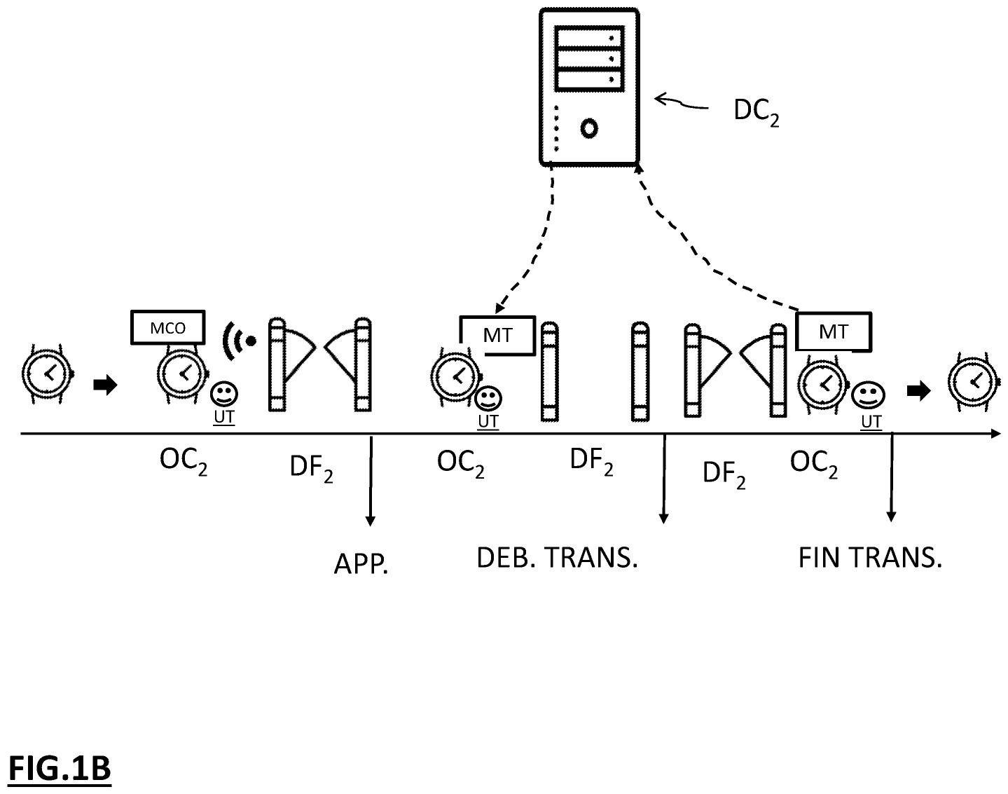

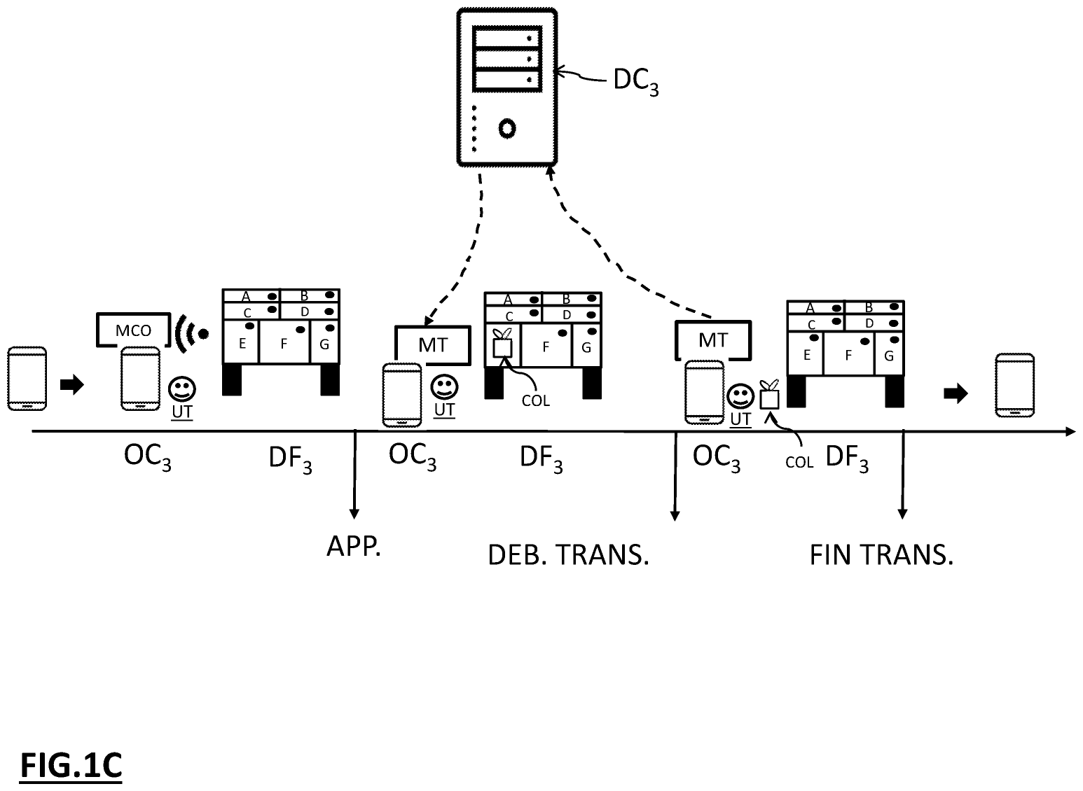

FIG. 1A shows a system for controlling a contactless transaction according to a first embodiment of the invention.

Such a system comprises:
a connected or communicating object OC₁ associated with a user UT,
a provision device DF₁ for providing a product or a service to the user UT,
a communication device DC₁ configured to communicate with the object OC₁ in order to implement a contactless transaction in relation to the provision of a product or a service by the device DF₁.

Communicating or connected object is the name given to any object configured to capture data and to communicate with other objects or with dedicated infrastructures using IoT (Internet of Things) technology.

According to the invention, the method for controlling a contactless transaction is implemented on the communicating object OC₁, completely autonomously, as will be described later in the description.

In the example of FIG. 1A, the communicating object OC₁ is for example a vehicle, here a connected electric car. As such, the car OC₁ is natively equipped with a plurality of sensors/detectors, such as for example a camera, a sensor that detects the state of charge of the battery, a speed sensor, a GPS (Global Positioning System) geolocation device, a fingerprint sensor, etc.

According to the invention, the connected car OC₁ is equipped with:
a short-range or medium-range wireless radio communication module MCO, such as for example Bluetooth, LTE, Wi-Fi, DSRC, C-V2X, etc.,
a contactless transaction module MT, for example an eSIM (embedded subscriber identification module) card installed in the car, an electronic wallet (e-wallet) embedded in the computing infrastructure of the car and in which one or more bank card digital currency units (tokens) has/have been preloaded, etc.

In the example of FIG. 1A, the provision device DF₁ for providing products or services is one charging terminal among others available in a charging station for electric vehicles. In the example shown, the charging terminal is numbered 3. In the example of FIG. 1A, the communication device DC₁ is a payment server or an EPT that may be contained within the charging terminal DF₁ or else dissociated therefrom.

In this contactless transaction context of the invention, the connected electric car OC₁ starts by pairing with the charging terminal DF₁, via its communication module MCO, so as to establish a secure contactless communication channel in order to implement the contactless transaction, here a payment corresponding to the charging carried out. This contactless transaction is controlled by the connected car OC₁, starting from the time when the user UT connected the charging connector of the terminal DF₁ to the battery of the connected car OC₁. If the connected car OC₁ considers that the contactless transaction is valid/legitimate, the contactless transaction begins, and then ends once the user has replaced the charging connector on the terminal. Of course, this example is in no way exhaustive. In particular, the provision device DF₁ for providing products or services varies depending on the use context of the connected car OC₁. To this end, the provision device DF₁ for providing products or services could be, as an alternative:
a petrol pump,
a take-away food kiosk,
a parking meter,
a toll barrier,
etc.

FIG. 1B shows a system for controlling a contactless transaction according to a second embodiment of the invention. This second embodiment uses elements in common with those of FIG. 1A. For this reason, these elements are designated with the same references.

Such a system comprises:
a connected or communicating object OC₂ associated with a user UT,
a provision device DF₂ for providing a product or a service to the user UT,
a communication device DC₂ configured to communicate with the object OC₂ in order to implement a transaction in relation to the provision of a product or a service by the device DF₂.

According to the invention, the method for controlling a contactless transaction is implemented on the communicating object OC₂, completely autonomously, as will be described later in the description.

In the example of FIG. 1B, the communicating object OC₂ is an object carried or worn by the user UT, such as for example a connected watch. It could of course be a tablet, a badge, a bracelet, glasses, etc.

As such, the watch OC₂ is natively equipped with a plurality of sensors/detectors, such as for example a camera, a photographic camera, an accelerometer, a GPS geolocation device, a fingerprint sensor, etc.

According to the invention, the connected watch OC₂ is equipped with:
the abovementioned communication module MCO,
a contactless transaction module MT, for example an electronic wallet embedded in the connected watch OC₃, in which one or more digital transport tickets (tokens), a particular identifier IDGT associated with the electronic wallet, etc. has/have been preloaded.

In the example of FIG. 1B, the provision device DF₂ for providing products or services is an access gate to a means of transport, such as for example the metro, the train, the tram, etc. It may also be a terminal arranged on a bus or a tram, near a platform in a railway station, etc.

In the example of FIG. 1B, the communication device DC₂ is an access control server that may be contained within the gate DF₂ or else dissociated therefrom. In this contactless transaction context of the invention, the connected watch OC₂ starts by pairing with the gate DF₂, via its communication module MCO, so as to establish a secure contactless communication channel in order to implement the contactless transaction, here accessing a means of transport. This contactless transaction is controlled by the connected watch OC₂, starting from the time when the user UT is a few centimeters away from the gate DF₂. If the connected watch OC₂ considers that the contactless transaction is valid/legitimate, the contactless transaction begins with the server DC₂, which causes the gate DF₂ to open in order to let the user UT through, and then ends once the user UT has passed through this gate. Such access control for example decrements one or more digital transport tickets preloaded in the electronic wallet of the connected watch OC₂. According to another example, such access control for example checks the particular identifier IDGT associated with the electronic wallet of the connected watch OC₂ for the purpose of automatically validating access to the means of transport on the basis of this particular identifier.

FIG. 1C shows a system for controlling a contactless transaction according to a third embodiment of the invention. This third embodiment uses elements in common with those of FIGS. 1A and 1B. For this reason, these elements are designated with the same references.

Such a system comprises:
a connected or communicating object OCs associated with a user UT,
a provision device DF₃ for providing a product or a service to the user UT,
a communication device DC₃ configured to communicate with the object OC₃ in order to implement a transaction in relation to the provision of a product or a service by the device DF₃.

According to the invention, the method for controlling a contactless transaction is implemented on the communicating object OC₃, completely autonomously, as will be described later in the description.

In the example of FIG. 1C, the communicating object OC₃ is an object carried or worn by the user UT, such as for example a smartphone. It could of course, as a variant, be a tablet, a badge, a bracelet, etc.

As such, the smartphone OCs is natively equipped with a plurality of sensors/detectors, such as for example a camera, a photographic camera, an accelerometer, a GPS geolocation device, a biometric sensor, etc.

According to the invention, the smartphone OC₃ is equipped with:
the abovementioned communication module MCO,
a contactless transaction module MT, for example a memory storing an identifier for collecting an order for a product or service placed beforehand by the user UT.

In the example of FIG. 1C, the provision device DF₃ for providing the product or service ordered by the user UT is an automatic parcel collection locker unit. In the example shown, this locker unit comprises seven lockers referenced A to G.

In the example of FIG. 1C, the communication device DC₃ is a server for controlling opening/closing of the lockers. The server DC₃ may be contained within the collection locker unit DF₃ or else dissociated therefrom.

In this contactless transaction context of the invention, the smartphone OC₃ starts by pairing with the collection locker unit DF₃, via its communication module MCO, so as to establish a secure contactless communication channel in order to implement the contactless transaction, here collection of a parcel COL. This contactless transaction is controlled by the smartphone OC₃, starting from the time when the user UT is a few centimeters away from the collection locker unit DF₃. If the smartphone OC₃ considers that the contactless transaction with the server DC₃ is valid/legitimate, the contactless transaction begins with the server DC₃, which results in the opening of one of the lockers that contains the parcel COL, the locker E in the example shown. The contactless transaction ends once the user UT has removed the parcel COL from the locker E and said locker has been closed. Such access control for example checks that the collection identifier stored in the memory of the smartphone OC₃ actually corresponds to the identifier of the parcel COL awaiting collection in the locker E, for the purpose of causing this locker to open automatically, without the user UT having to manipulate their smartphone OC₃.

### Description of One Embodiment of the Communicating Object OC

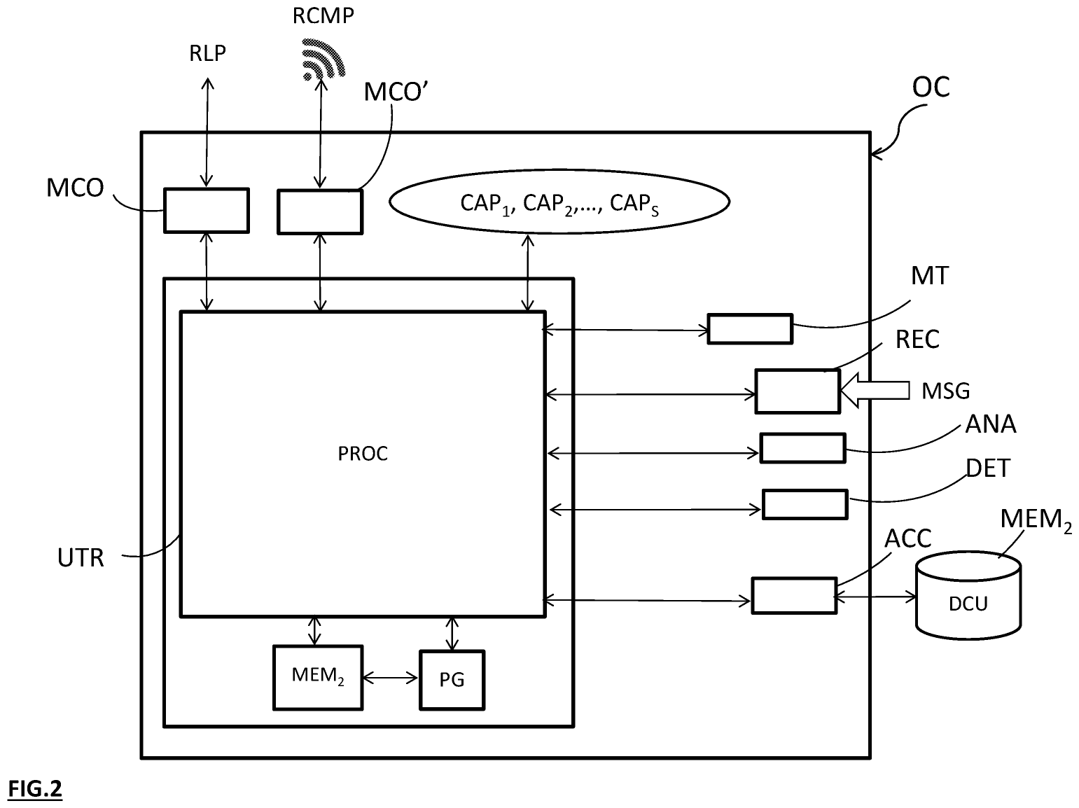

FIG. 2 shows the simplified structure of the communicating object OC, such as for example the object OC₁, OC₂ or OC₃ from FIGS. 1A to 1C, which communicating object is designed to implement the method for controlling a contactless transaction that will be described below.

As already explained above, such a communicating object conventionally comprises:
a communication module MCO designed to communicate, via a short-range or medium-range wireless data network RCMP, such as for example Bluetooth, NFC, LTE, Wi-Fi, DSRC, C-V2X, etc.,
one or more sensors/detectors CAP₁, CAP₂, . . . , CAP_{S} (S≥1).

The communicating object OC furthermore comprises, according to the invention:
a communication module MCO′ designed to communicate via a long-range data network RLP (3G, 4G, 5G, etc.),
a reception module REC for receiving broadcast messages MSG, for example of beacon type or of V2X (Vehicle-to-Everything) type, when the communicating object OC is more particularly a vehicle, these broadcast messages being received from various devices and/or infrastructures that the communicating object encounters on its path,
a transaction module MT, such as for example a SIM card, eSIM card, e-wallet, a memory dedicated to contactless transactions, etc.,
an analysis module ANA configured to analyze transaction data DAT1 contained in the transaction requests that the communicating object OC receives from a communication device DC, such as for example the communication device DC₁, DC₂ or DC₃ from FIGS. 1A to 1C,
a module DET configured to determine at least one additional transaction datum DAT2 in addition to that (those) already contained in the received transaction requests,
an access module ACC for accessing a memory MEM₁ that contains use context data/information DCU in relation to the communicating object OC, examples of which will be given later in the description.

In FIG. 2, the memory MEM₁ is not contained within the communicating object OC in order to preserve the memory resources thereof. To this end, the memory MEM₁ is transferred to a communication network, a cloud, etc. and is made accessible to the communicating object OC by way of the module ACC dedicated for this purpose. As a variant, the memory MEM₁ or a part thereof, could be integrated into the communicating object OC.

Although in FIG. 2 the module DET for determining at least one additional transaction datum DAT2 is integrated into the communicating object OC, the module DET could be dissociated from this object in order to preserve the computing resources thereof.

According to one particular embodiment of the invention, the actions executed by the communicating object OC, in the context of implementing the method for controlling a contactless transaction according to the present invention, are implemented by instructions of a computer program PG. For this purpose, the communicating object OC has the conventional architecture of a computer and comprises in particular a memory MEM₂, a processing unit UTR, equipped for example with a processor PROC, and driven by the computer program PG stored in memory MEM₂. The computer program PG comprises instructions for implementing the actions executed by the communicating object OC when the program is executed by the processor PROC, according to any one of the particular embodiments of the invention. On initialization, the code instructions of the computer program PG are for example loaded into a RAM memory (not shown), before being executed by the processor PROC. The processor PROC of the processing unit UTR implements in particular the actions of collecting data from the one and/or more sensors CAP₁, CAP₂, . . . , CAP_{S}, the actions of receiving the one and/or more messages MSG, the actions of receiving transaction requests, the actions of analyzing these requests, the actions of determining at least one additional transaction datum, and the actions of sending or not sending a response to these transaction requests.

### Description of One Embodiment of a Method for Controlling a Contactless Transaction

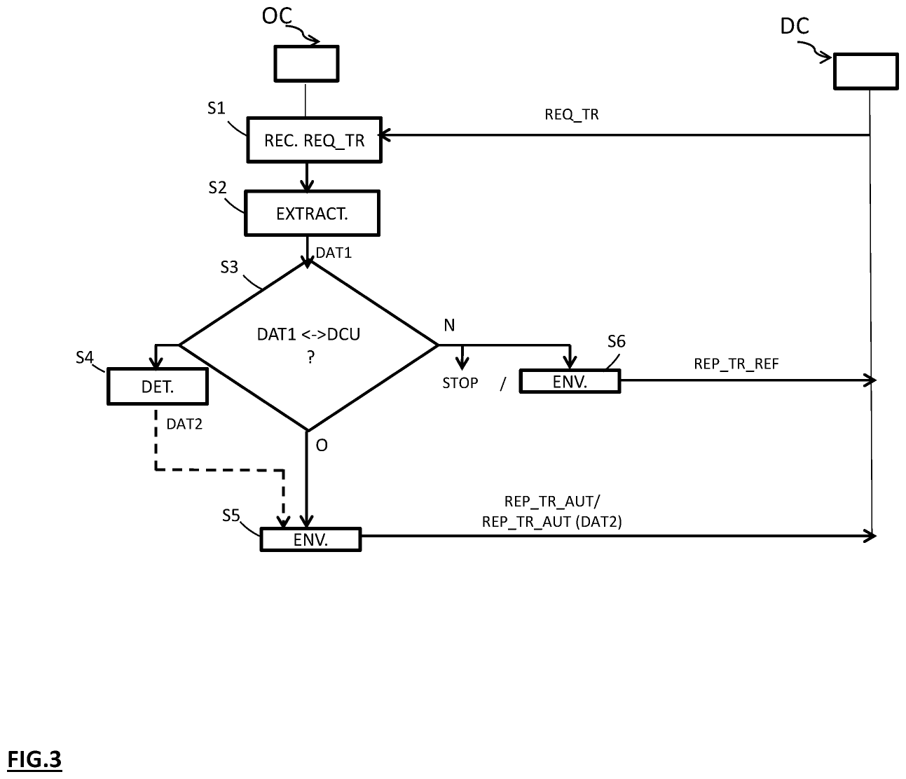

A description will now be given, with reference to FIG. 3, of the carrying out of a method for controlling a contactless transaction executed by a communicating object OC, such as for example the object OC₁, OC₂ or OC₃ from FIGS. 1A to 1C, according to one embodiment of the invention. Such a contactless transaction is established during contactless communication between the communicating object OC and the abovementioned communication device DC, such as for example the communication device DC₁, DC₂ or DC₃ from FIGS. 1A to 1C. The subject of the contactless transaction is for example a product or a service provided by a provision device DF for providing products or services to the user UT of the communicating object OC, such as for example the provision device DF₁, DF₂ or DF₃ for providing products or services from FIGS. 1A to 1C.

According to the invention, the communicating object OC is configured such that it autonomously executes the various actions that will be described below in order to control a contactless transaction with the communication device DC, as if it were the user UT themselves who were implementing such control, namely checking the legitimacy of the transaction, as the user usually does by checking for example that the subject of the transaction is the one they want, that the price of the subject, when it is paid for, is actually correct, the location of the transaction, etc., and validating or not validating the transaction based on this check.

Prior to carrying out the method for controlling a contactless transaction described below, it is considered that the user UT and their communicating object OC have been brought toward the provision device DF for providing products or services and that a communication channel has been established securely in order to implement the contactless transaction between the communicating object OC and the communication device DC. The establishment of such a communication channel or pairing is conventional and will not be described further. In one particular embodiment, such a communication channel is established autonomously by the communicating object OC as described in document FR2106702, incorporated into the present description by reference.

The method for controlling a contactless transaction then takes place as follows: In S1, the communicating object OC receives, from the communication device DC, a request REQ_TR containing data DAT1 relating to a transaction. Such a request may be received by the communication module MCO or MCO′ from FIG. 2. In the use context of FIG. 1A, the request REQ_TR is for example a payment request. This may be for example a SEPA RTP (“Single Euro Payments Area Request to Pay”) request, a Paypal request:

https://developer.paypal.com/docs/integration/paypal-plus/mexico-brazil/create-a-payment-request/, etc., for which the data DAT1 correspond for example:
to the amount of the transaction, here the price of the electricity charging,
to the type of product or service involved in the transaction, here “battery charging”,
to an identifier of the provision device DC for providing products or services, here charging terminal no. 3,
to the location of the transaction, here the geolocation data in relation to the charging station,
to an amount or volume linked to the product or service that is the subject of the transaction, here the amount of electricity consumed to charge the battery of the connected electric car OC₁.

In the use context of FIG. 1B, the request REQ_TR is for example an identification request for accessing the means of transport. Such a request is for example an Internet request. It contains data DAT1 corresponding for example:
to an identifier of the gate DF₂: for example, this identifier may start with the letter “M” to indicate that it involves a metro gate, with the letter “B” to indicate that it involves the access terminal of a bus, etc.,
the category of the means of transport corresponding to the device DF₂: bus, metro, train, tram, etc.,
the price of one or more transport tickets,
the particular identifier IDGT for free access to transport that is associated with the transaction module MT of the connected watch OC₂,
etc.

In the use context of FIG. 1C, the request REQ_TR is for example a request to access the parcel collection locker unit DF₃. Such a request is for example an Internet request. It contains data DAT1 corresponding for example:
to a collection identifier, such as for example a delivery code, the letter “G” of the locker that contains the parcel COL, etc.
to an identifier or name of the brand of the store where the parcel COL comes from,
to the price of the order,
to the number of items delivered,
to the location where the parcel collection locker unit is located,
etc.

The method for controlling the contactless transaction continues in S2, where the communicating object OC extracts the data DAT1 from the received request REQ TR.

In S3, the analysis module ANA from FIG. 2 analyzes these data DAT1. For this purpose, the data DAT1 are compared with use context data DCU in relation to the communicating object OC.

The use context data/information DCU are data/information collected by the communicating object OC while it is moving toward the provision device DF for providing a product or service, but also prior to this movement.

In one embodiment, the use context data/information DCU:
are data/information INF1 representative of an environment in which the communicating object OC is located: they may for example be one or more items of information conveyed in a message MSG received by the reception module REC from FIG. 2, from the communication device DC or from a message-transmitting device located in the environment of the communicating object OC, or else one or more data from at least one of the sensors CAP₁ to CAP_{S} from FIG. 2; and/or
contain at least one operating datum INF2 in relation to the communicating object OC, such as for example a current operating parameter recorded by the communicating object OC, and/or
contain at least one element INF3 of a history of transactions already carried out by the communicating object OC, and/or
contain one or more elements INF4 from a list of types of known fraud, and/or
contain one or more elements INF5 from a blacklist of fraudsters LNF,
etc.

During or at the end of this comparison S3, one or more additional transaction data DAT2 are determined or identified in S4 using the module DET from FIG. 2. Such determination may be carried out locally by the communicating object OC or remotely.

In the use context of FIG. 1A, the data/information INF1 representative of an environment in which the connected electric car OC₁ is located are received by the car OC₁, via the reception module REC from FIG. 2. They are conveyed for example in a message MSG broadcast for example by the server DC₁ or by the search terminal DF₁, depending on the envisaged communication context. The message MSG may also be broadcast by any appropriate infrastructure, such as the charging station that manages all charging terminals, a restaurant, a traffic control center, a local authority, etc.

Such a message MSG is for example of beacon, V2X, UWB (Ultra-wideband), Wi-Fi multicast, or even Li-Fi (Light Fidelity) type, etc.

Typically, this item of information INF1 designates for example:
the name of the charging station where the charging terminal DF₁ is located, the number of this terminal, etc.
the type of fuel, for example “electricity”, associated with the charging terminal DF₁,
etc.

The data/information INF1 may also correspond to an interpretation made by the connected electric car OC₁ of the data from its various sensors CAP₁ to CAP_{S}, typically the level of charge of electricity of its battery, the dimensions or the type of the car OC₁, the one or more occupants of the car OC₁ (biometrics), etc. The data/information INF1 may also correspond for example to a brand or logo of the charging station that have been recognized after analyzing an image or video captured by one of the sensors CAP₁, CAP₂, . . . , CAP_{S} of the car OC₁, typically a photographic camera or a camera. They may also involve metadata associated with this image, such as for example the geographical position of the charging station, the date and/or the time of capture of the image or video. The data/information INF1 also correspond, in this use context, to the geographical coordinates (Cartesian, polar, spherical, etc.) of the car OC₁ that are measured by one of the sensors CAP₁, CAP₂, . . . , CAP_{S} of the car OC₁, typically a GPS device.

In the use context of FIG. 1A, the operating data/information INF2 in relation to the connected car OC₁ correspond to the parameters related to the infrastructure of the car OC₁ and fed back via a multiplexer or a data bus installed in the car. This involves for example the current speed, the opening/closing of the fuel/electrical charging flap, the decrease/increase in the fuel level/the battery level, the opening/closing of a door, etc.

In the use context of FIG. 1A, the element INF3 of a history of transactions already carried out by the car OC₁ is typically an item of information relating to payments previously made by the car OC₁.

In the use context of FIG. 1A, the additional transaction data DAT2 are for example the identity of the person driving the car OC₁, the mileage traveled, the location of the car OC₁ at the time of the payment. If the connected car OC₁ is shared by multiple people or multiple companies and therefore contains multiple transaction modules MT, here payment modules, the additional data DAT2 correspond to an identifier of the payment module associated with the person identified beforehand by a biometric sensor of the car OC₁. The determination step S4 thus advantageously makes it possible to automatically select the transaction module MT associated with the actual user UT of the communicating object OC when multiple users are potentially able to use this object.

In the use context of FIG. 1B, the data/information INF1 representative of an environment in which the connected watch OC₂ is located are received via the reception module REC from FIG. 2. They are conveyed for example in a message MSG broadcast for example by the server DC₂ or by the gate DF₂, depending on the envisaged communication context. The message MSG may also be broadcast by a transmitter situated in a railway station or in a station, in the metro, on the bus, etc. Typically, the data/information INF1 designate for example the name of a station or a bus/tram stop, the identifier of a transport line, geolocation information in relation to the connected watch OC₂ in the railway station or the station, the type of means of transport taken, for example “metro”, associated with the gate DF₂, etc. Such a message MSG is for example of beacon, UWB (Ultra-wideband), Wi-Fi multicast, or even Li-Fi (Light Fidelity) type, etc.

The data/information INF1 may also correspond to an interpretation made by the connected watch OC₂ of the data from its various sensors CAP₁ to CAP_{S}. They correspond for example to the name of the station or of the railway station, to an identifier of the transport line taken by the user UT, etc. that have been recognized after analyzing an image or video captured by one of the sensors CAP₁, CAP₂, . . . , CAP_{S} of the watch OC₂, typically a photographic camera or a camera. They may also involve metadata associated with this image, such as the geographical position of the station or of the railway station, the date and/or the time of capture of the image or video. The data/information INF1 may also correspond, in this use context:
to a speed measured by one of the sensors CAP₁, CAP₂, . . . , CAP_{S} of the watch OC₂, typically an accelerometer,
to the geographical coordinates (Cartesian, polar, spherical, etc.) of the watch OC₂ that are measured by one of the sensors CAP₁, CAP₂, . . . , CAP_{S} of the watch OC₂, typically a GPS device.

In the use context of FIG. 1B, the operating data/information INF2 in relation to the connected watch OC₂ correspond for example to the current date and time. In the use context of FIG. 1B, the element INF3 of a history of transactions already carried out by the connected watch OC₂ is typically an item of information relating to journeys previously made on public transport by the user UT.

In the use context of FIG. 1B, the additional transaction data DAT2 are for example the identity of the user UT wearing the connected watch OC₂, the location of the connected watch OC₂ at the time when the user UT passes through the gate DF₂, the number of remaining digital tickets, etc. If the connected watch OC₂ is shared by various users and therefore contains multiple transaction modules, here digital transport cards integrated into the watch OC₂, the additional data DAT2 correspond to an identifier of the transport card associated with the person identified beforehand, for example using a biometric sensor of the connected watch OC₂.

In the use context of FIG. 1C, the data/information INF1 representative of an environment in which the smartphone OC₃ is located are received via the reception module REC from FIG. 2. They are conveyed for example in a message MSG broadcast for example by the server DC₃ or by the collection locker unit DF₃, depending on the envisaged communication context. The message MSG may also be broadcast by a transmitter situated near the collection locker unit DF₃. Typically, the data/information INF1 designate for example the name or an identifier of the collection locker unit DF₃, a location where the collection locker unit DF₃ is located, the location of the smartphone OC₃ with respect to the collection locker unit DF₃, etc. Such a message MSG is for example of beacon, push notification, UWB (Ultra-wideband), Wi-Fi multicast, or even Li-Fi (Light Fidelity) type, etc.

The data/information INF1 may also correspond to an interpretation made by the smartphone OC₃ of the data from its various sensors CAP₁ to CAP_{S}. They correspond for example to the name or to an identifier of the collection locker unit DF₃ that have been identified after analyzing an image or video captured by one of the sensors CAP₁, CAP₂, . . . , CAP_{S} of the smartphone OC₃, typically a photographic camera or a camera. They may also involve metadata associated with this image, such as the geographical position of the collection locker unit DF₃, the date and/or the time of capture of the image or video. The data/information INF1 may also correspond, in this use context:
to a speed measured by one of the sensors CAP₁, CAP₂, . . . , CAP_{S} of the smartphone OC₃, typically an accelerometer, -
the geographical coordinates (Cartesian, polar, spherical, etc.) of the smartphone OC₃ that are measured by one of the sensors CAP₁, CAP₂, . . . , CAP_{S} of the watch OC₃, typically a GPS device.

In the use context of FIG. 1B, the operating data/information INF2 in relation to the smartphone OC₃ correspond for example to the current date and time, to the current operating mode of the smartphone OC₃ (on, off, airplane mode, standby, etc.).

In the use context of FIG. 1C, the element INF3 of a history of transactions already carried out by the smartphone OC₃ is typically an item of information relating to the various orders for products or services that have previously been placed by the user UT with the smartphone OC₃.

In the use context of FIG. 1C, the additional transaction data DAT2 are for example the identity of the user UT using the smartphone OC₃, data from a profile of this user UT (browsing history, directory, etc.) loaded into the smartphone OC₃ when the user UT turns on the smartphone OC₃, the location of the smartphone OC₃ at the time when the user UT moved toward the collection locker unit DF₃, a logo of the delivery brand delivering the parcel COL, the telecommunications operator linked to the eSIM card MT, etc. If the smartphone OC₃ is shared by various users and therefore contains multiple transaction modules MT integrated into the smartphone OC₃, here eSIM card, e-wallet, etc., the additional data DAT2 correspond to an identifier of the eSIM card, e-wallet or the like associated with the person identified beforehand, for example using a biometric sensor of the smartphone OC₃.

If there is a match between the data DAT1 and the use context data DCU in relation to the communicating object OC (Y in FIG. 3), the communicating object OC identifies the transaction as valid/legitimate. To this end, in S5, it activates sending, to the communication device DC, via its communication module MCO or MCO′, of a response REP_TR_AUT to the request REQ_TR, said response REP_TR_AUT authorizing the transaction between the communicating object OC and the communication device DC.

In one particular embodiment, the response REP_TR_AUT may be enriched by at least one datum DAT2 that was determined in S4. The one and/or more data DAT2 may thus be transmitted by the communication device DC both to the manager of the transaction and to the manager of the communicating object (for example: manager of a fleet of vehicles, bank, etc., if the communicating object OC is a connected car OC₁, public transport authority if the communicating object OC is a connected watch OC₂, telecommunications operator or delivery brand if the communicating object OC is a smartphone OC₃), or else to the provider of the product or service that is the subject of the transaction (service station, merchant website, etc.). These one or more data DAT2 may thus be advantageously utilized for the purposes of processing/archiving/tracing transactions that have been carried out by a user UT of the given communicating object OC, at a given time.

If there is not a match between the data DAT1 and the use context data DCU in relation to the communicating object OC (N in FIG. 3), the communicating object OC identifies the transaction as invalid/illegitimate. To this end, in S6, it activates sending, to the communication device DC, via its communication module MCO or MCO′, of a response REP_TR_REF to the request REQ_TR, said response

REP_TR_REF designating declining of the transaction between the communicating object OC and the communication device DC. As an alternative, the communicating object OC does not send any response to the request REQ_TR and the transaction method ends after a period that is set beforehand, the duration of which depends on the implementation carried out.

The steps of the method for controlling a contactless transaction that have just been described above advantageously allow any connected object to check whether or not a transaction (payment, access, order collection, etc.) with a communication device (payment server, access control server or gate, opening/closing command for a parcel collection locker unit, an automatic locker, etc.) is valid/legitimate, and to do so completely autonomously and securely.

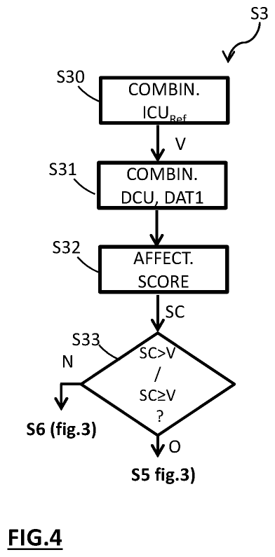

A description will now be given, with reference to FIG. 4, of one embodiment of the comparison implemented during step S3 of FIG. 3 to characterize the match or lack of match between the data DAT1 and the use context data DCU in relation to the communicating object OC. Such a comparison is implemented using an artificial-intelligence computerized processing tool.

To this end, the comparison S3 comprises a sub-step S30 during which items of reference use context information ICU_{Ref} are combined.

These items of reference use context information ICU_{Ref} may take various forms. These may be for example:
information characterizing a contactless transaction situation of a communicating object as being valid/legitimate and that has been learned beforehand, for example using a neural network, and/or
rules written a priori and according to which the data DAT1 and/or the use context data DCU will be combined in a particular way, using for example an expert system, and/or
pooling of contactless transaction situations detected beforehand with regard to the communicating object OC, in a similar or identical contactless transaction context (for example: case where the communicating object OC is shared by users other than the user UT),
etc.

At the end of sub-step S30, a reliability score having a value V is obtained.

In S31, the data DAT1 and the use context data DCU are combined.

In S32, a reliability score SC is assigned to the result of this combination.

In S33, the score SC is compared with the value V obtained in S30, which is considered as a reference value.

According to one embodiment, 0≤V≤1. Other bounding values are of course possible depending on the implementation of the method for controlling a contactless transaction. One convention establishes for example that V=0.6 and that, beyond this reference value V, the communicating object OC is in a valid/legitimate transaction situation.

If SC>V (or SC>V depending on the established convention) (Y in FIG. 4), step S5 of activating reception of pairing requests is triggered. If SC≤V (or SC<V depending on the established convention) (N in FIG. 4), step S6 of stopping the transaction control method or of sending a response REP_TR_REF declining the transaction is implemented.

In one particular embodiment, depending on the value of the score SC, and in particular if the value of the score SC is very close to the reference value V, below or above it, additional data may be used to refine the comparison S3, such as for example data from an external database of known fraud (to detect a risky transaction situation), data provided by the user UT if they are present at the time when the comparison S3 is implemented, data corresponding to the selection of a specific transaction module MT (for example a transaction module benefiting from particular assurance, a transaction module having a particular identifier IDGT that authorizes free public transport, etc.).

In the transaction context of FIG. 1A, in which the communicating object OC is a connected electric car OC₁ that wishes to pay autonomously for charging its battery, the determined use context information DCU is for example:
the speed of the car OC₁ is zero,
the engine of the car OC₁ is switched off,
the level of the battery is low,
the category “charging terminal” is identified in a message MSG.

The data DAT1 are for example the date and time of day along with the payment amount for the charging.

This information is compared, in S3, with a learning situation that has been modeled with reference use context information ICU_{Ref} of the same type as or a type similar to the use context information DCU and the data DAT1 and that has already been evaluated beforehand in an identical or similar use context:
for the car OC₁, or
for another car or any other type of vehicle belonging for example to a fleet of vehicles to which the car OC₁ belongs.

Thus, if, in S31, all of the use context information DCU and the transaction data DAT1 match the reference use context information ICU_{Ref}, the value of the reliability score SC assigned in S32 will be greater than V or greater than or equal to V.

If, on the other hand, the determined use context information DCU is for example:
the speed of the car OC₁ is zero,
the engine of the car OC₁ is switched off,
the fuel tank level is low,
the category “parking” is identified in a message MSG, and the data DAT1 are for example the date and time of day along with the payment amount for a baguette,
then the value of the reliability score SC assigned in S32 will be less than V or less than or equal to V in order to characterize the fact that there are one or more inconsistencies between the use context information DCU and the data DAT1.

In the use context of FIG. 1B, in which the communicating object OC is a connected watch OC₂, the determined use context information DCU is for example:
the name of the bus stop,
geolocation data in relation to the connected watch with respect to this stop,
the identifier of the line that is indicated for example on the approaching bus,
a decreasing speed of the connected watch,
etc.

The data DAT1 are for example an identifier of a gate that begins with the letter “B” to indicate that the means of transport taken is a bus,
the category of the means of transport taken: “bus”,
the price for accessing this bus.

This information is compared with a learning situation that has been modeled with reference use context information ICU_{Ref} of the same type as or a type similar to the use context information DCU and that has already been evaluated beforehand in an identical or similar use context of a means of transport and representative of the public transport travel habits of the user UT or of another user who shares the connected watch OC₂ with the user UT.

Thus, if, in S31, all of the use context information DCU and the transaction data DAT1 match the reference use context information ICU_{Ref}, the value of the reliability score SC assigned in S32 will be greater than V or greater than or equal to V.

If, on the other hand, the determined use context information DCU is for example:
the name of a metro station broadcast in a message MSG,
geolocation data in relation to the connected watch with respect to a bus stop,
the identifier of a bus that does not stop at the bus stop corresponding to the geolocation data,
a decreasing speed of the connected watch,
etc.
and the data DAT1 are for example the date and time of day along with the amount for a train ticket,
then the value of the reliability score SC assigned in S32 will be less than V or less than or equal to V in order to characterize the fact that there are one or more inconsistencies between the use context information DCU and the data DAT1.

In the use context of FIG. 1C, in which the communicating object OC is a smartphone OC₃, the determined use context information DCU is for example:
the name or an identifier of the collection locker unit DF₃ broadcast in a message MSG,
a logo of the delivery brand delivering the parcel COL,
data from the browsing history of the smartphone OC₃ showing that the user UT ordered a particular product or service on a given date.

The data DAT1 are for example the date and time of day along with the price of the order to be collected and a number of items corresponding to the order, which is equal to 3.

These one or more items of information is/are compared with a learning situation that has been modeled with one or more items of reference use context information ICU_{Ref} of the same type as or a type similar to the use context information DCU and that has already been evaluated beforehand in an identical or similar use context that defines the parcel collection locations that the user UT visits most often, known purchase kinematics of the user UT or of another user sharing the smartphone OC₃ with the user UT, etc.

Thus, if, in S31, all of the use context information DCU and the data DAT1 match the reference use context information ICU_{Ref}, the value of the reliability score SC assigned in S32 will be greater than V or greater than or equal to V.

If, on the other hand, the determined use context information DCU is for example:
the name or an identifier of the collection locker unit DF₃ broadcast in a message MSG,
a logo of a delivery brand delivering the parcel COL that is not authorized to deliver to the collection locker unit DF₃ corresponding to the abovementioned identifier or name,
data from the browsing history of the smartphone OC₃ showing that the user UT has ordered a single item.

The data DAT1 are for example the date and time of day along with the price of the order to be collected, which corresponds to a number of items equal to 3,
then the value of the reliability score SC assigned in S32 will be less than V or less than or equal to V in order to characterize the fact that there are one or more inconsistencies between the use context information DCU and the data DAT1.

1. A method for controlling a contactless transaction between a communicating object and a communication device, during which the communicating object receives, from the communication device, a request containing data relating to the transaction, the method comprising:
the communicating object autonomously executes executing the following:
extracting information relating to the transaction from said received request;
comparing the extracted information with use context data in relation to the communicating object that have been determined by the object; and
activating sending, to the communication device, of a response to the request authorizing the transaction in response to a match between the information relating to the transaction and the use context data.

2. The method for controlling a contactless transaction as claimed in claim 1, wherein the method further comprises, in the absence of a match between the information relating to the transaction and the use context data, the communicating object either activating sending, to the communication device, a response to the request declining the transaction, or not responding to the request.

3. The method for controlling a contactless transaction as claimed in claim 1, wherein, during the comparison of the extracted information with said use context data, at least one additional datum relating to the transaction is determined, said at least one additional datum being added to the response to the request authorizing the transaction.

4. The method for controlling a contactless transaction as claimed in claim 3, wherein, in response to the transaction being a payment and the communicating object comprising at least two means of payment associated respectively with two different users, the at least one additional datum is an identifier of the means of payment associated with the user of the object at a time of the transaction.

5. The method for controlling a contactless transaction as claimed in claim 1, wherein comparing the extracted information with said use context data comprises the following:
generating a reliability score for the comparison,
comparing the generated score with a threshold,
depending on a result of the comparison:
activating sending, to the communication device, the response to the request authorizing the transaction,
activating sending, to the communication device, a response to the request declining the transaction or not responding to the request.

6. The method for controlling a contactless transaction as claimed in claim 1, wherein the use context data in relation to the communicating object are representative of an environment in which the communicating object is located or contain at least one operating datum in relation to the communicating object.

7. The method for controlling a contactless transaction as claimed in claim 6, wherein the at least one operating datum in relation to the communicating object is a current operating parameter recorded by the communicating object or an element of a history of transactions carried out by the communicating object.

8. The method for controlling a contactless transaction as claimed in claim 1, wherein the use context data representative of an environment in which the communicating object is located are contained in a message received by the communicating object from a communication device or from a message-transmitting device located in said environment.

9. The method for controlling a contactless transaction as claimed in claim 1, wherein the use context data representative of an environment in which the communicating object is located contains a datum from at least one sensor belonging to the communicating object.

10. A communicating object having abilities to control a contactless transaction with a communication device, said communicating object comprising:
a processor that is configured to receive, from the communication device, a request containing data relating to the transaction, and to autonomously execute the following:
extracting information relating to the transaction from the received request;
comparing the extracted information with use context data in relation to the communicating object that have been determined by the object,; and
activating sending, to the communication device, of a response to the request authorizing the transaction in response to a match between the information relating to the transaction and the use context data.

11. (canceled)

12. A non-transitory computer-readable information medium comprising instructions of a computer program stored thereon which when executed by a processor of a communicating object configure the communicating object to implement a method of controlling a contactless transaction between the communicating object and a communication device, during which the communicating object receives, from the communication device, a request containing data relating to the transaction, the method comprising:
the communicating object autonomously executing the following:
extracting information relating to the transaction from said received request;
comparing the extracted information with use context data in relation to the communicating object that have been determined by the object; and
activating sending, to the communication device, a response to the request authorizing the transaction in response to a match between the information relating to the transaction and the use context data.

13. (canceled)

14. The communicating object as claimed in claim 10, wherein the processor is further configured to execute, in the absence of a match between the information relating to the transaction and the use context data, either activating sending, to the communication device, a response to the request declining the transaction, or not responding to the request.

15. The communicating object as claimed in claim 10, wherein the processor is further configured to determine, during the comparison of the extracted information with said use context data, at least one additional datum relating to the transaction, said at least one additional datum being added to the response to the request authorizing the transaction.

16. The communicating object as claimed in claim 15, wherein, in response to the transaction being a payment and the communicating object comprising at least two means of payment associated respectively with two different users, the at least one additional datum is an identifier of the means of payment associated with the user of the object at a time of the transaction.

17. The communicating object as claimed in claim 10, wherein comparing the extracted information with said use context data comprises the following:
generating a reliability score for the comparison, comparing the generated score with a threshold, depending on a result of the comparison:
activating sending, to the communication device, the response to the request authorizing the transaction,
activating sending, to the communication device, a response to the request declining the transaction or not responding to the request.

18. The communicating object as claimed in claim 10, wherein the use context data in relation to the communicating object are representative of an environment in which the communicating object is located or contain at least one operating datum in relation to the communicating object.

19. The communicating object as claimed in claim 18, wherein the at least one operating datum in relation to the communicating object is a current operating parameter recorded by the communicating object or an element of a history of transactions carried out by the communicating object.

20. The communicating object as claimed in claim 10, wherein the use context data representative of an environment in which the communicating object is located are contained in a message received by the communicating object from a communication device or from a message-transmitting device located in said environment.

21. The communicating object as claimed in claim 10, wherein the use context data representative of an environment in which the communicating object is located contains a datum from at least one sensor belonging to the communicating object.
